(19) United States
(12) Patent Application Publication
(10) Pub. No.: US 2018/0050424 A1
(43) Pub. Date: Feb. 22, 2018

(54) Method and Device for Splitting an Initial Metal Sheet, And Metal-Sheet Part

(71) Applicant: Schuler Pressen GmbH, Göppingen (DE)

(72) Inventor: Jürgen Fahrenbach, Aichelberg (DE)

(21) Appl. No.: 15/556,967

(22) PCT Filed: Mar. 1, 2016
(86) PCT No.: PCT/EP2016/054270

§ 371 Date: Sep. 8, 2017

(30) Foreign Application Priority Data
Mar. 9, 2015 (DE) 10 2015 103 418.2

(51) Int. Cl. B23K 26/364; B23D 31/00; B23D 33/02

(52) U.S. Cl. CPC B23K 26/364; H02K 15/02; B23D 33/02; B23D 31/002

(57) ABSTRACT

A sheet metal part (20) is produced from a starting sheet metal (27) and has at least one side edge (32) extending along the grain boundaries of the sheet metal material. Separating or breaking the starting sheet metal (27) at a separation location (28) is induced by forming a notch in the starting sheet metal or by cutting or scratching into the starting sheet metal. The starting sheet metal is clamped via a first portion (30) adjacently to the separation location (28). A second portion (31) disposed on the side of the separation location (28) opposite the first portion (30) is acted on to produce a bending moment M about a bending axis B at the separation location (28) and/or to produce a tensile force Z directed away from the separation location (28).

The invention relates to a method and to a device for separating a starting sheet metal at a separation location. The invention additionally relates to a sheet metal part which in particular is designed for use in a laminated core, such as a laminated core for a transformer, or an electric machine.

A method and a device for punching a starting sheet metal at a separation location are known for example from EP 1758697 B1. There, the starting sheet metal is clamped adjacently to a separation location. A die punch moves completely through the starting sheet metal with a punch edge along the separation location and in so doing separates off a portion of the starting sheet metal. In order to be able to punch high-strength sheet metals, it is proposed to additionally apply a bending moment to the starting sheet metal.

When a punching process is performed, a punching tool is moved through the starting sheet metal at the separation location. Other known separation methods for separating a sheet metal are laser cutting or water jet cutting, for example.

Proceeding from this basis, the object of the invention can be considered that of creating a method and a device for separating a starting sheet metal and also of creating a sheet metal part that are particularly suitable for use within a magnetic field.

This object is achieved by a method having the features of claim 1, by a device having the features of claim 10, and by a sheet metal part having the features of claim 15.

In accordance with the invention, the starting sheet metal is divided at the separation location into a first portion and a second portion. The resultant separation edge of the first portion and/or of the second portion of the starting sheet metal runs along the grain boundaries of the material of the starting sheet metal. It has been found that the magnetic flux at the separation edge is thus hindered to a much lesser extent and that the use of a sheet metal part having a side edge that is formed by at least one portion of the separation edge running along the grain boundaries increases the efficiency. It is anticipated that the magnetic flux density can be significantly increased with constant magnetic field strength.

In accordance with the invention the starting sheet metal is clamped in a first portion adjacently to the separation location. The second portion of the starting sheet metal is disposed on the side of the starting sheet metal opposite the first portion. Once the starting sheet metal has been clamped, a bending moment is applied to the starting sheet metal about a bending axis extending along the separation location and/or a tensile force directed away from the separation location is applied to the second portion. In contrast to other separation methods, the starting sheet metal is not fully penetrated at the separation location by a blade or edge, and instead the forming of a crack is initiated at the separation location, for example in that a shear stress is applied at an incline or transversely to the plane of extension of the starting sheet metal and/or a notch of shallow depth is formed. The starting sheet metal is not punched through or cut through at the separation location, and instead is merely notched or cut into or scratched into to a limited depth and/or is subjected to a shear stress, such that cracks and preferably microcracks form at the separation location in the starting sheet metal. Due to the bending moment acting at the separation location or due to the tensile force acting on the starting sheet metal, a fracture, preferably a brittle fracture, then forms along the separation location. The starting sheet metal then becomes separated or broken at the separation location between the first portion and the second portion, wherein separation edges are created, which run along the grain boundaries.

In order to produce the microcracks at the separation location whilst the bending moment and/or the tensile force are/is effective, a notch of limited depth can be made, wherein the depth of the notch is smaller than the thickness of the starting sheet metal at the separation location at least by a factor of 3 to 5. In addition or alternatively, a shear stress can also be produced on the starting sheet metal at the separation location, at an incline or transversely to the surface.

In an exemplary embodiment the notch and/or the tensile moment are/is produced using a mechanical blade acting on the starting sheet metal. Alternatively, it is also possible to form a notch in the starting sheet metal or to cut into said sheet metal by other means, such as lasers. The mechanical blade can act on the starting sheet metal for example at a cutting angle having a value of from 80° to 90° in relation to the plane of extension of the first portion.

In one exemplary embodiment the tensile force can act parallel to the second portion of the starting sheet metal. The tensile force acts here in the plane in which the second portion extends starting from the separation location.

The starting sheet metal is preferably separated at the separation location by the creation of a brittle fracture. It is particularly preferred if the starting sheet metal is cooled at least at the separation location before or during the separation process. By way of example, at least the separation location of the starting sheet metal can be cooled by a cooling fluid, such as liquid nitrogen (LN). The brittleness of the starting sheet metal can thus be increased, and the separation along the grain boundaries can be improved.

It is also advantageous if, after the separation along the separation location, at least one sheet metal part is separated from the first portion and/or the second portion by an arbitrary separation method. This sheet metal part has at least one side edge formed at least by a portion of the separation edge. This side edge thus runs along the grain boundary of the material of the starting sheet metal. This side edge is provided in particular so that, when the sheet metal part is used in a laminated core, magnetic field lines enter the sheet metal part and exit from the sheet metal part. This side edge thus forms a passing area, i.e. an exit and/or entry area, for magnetic field lines and by way of example can border an air gap, as is formed for example between the rotor and the stator of an electric machine.

A device according to the invention for separating a starting sheet metal has a clamping means, with which the first portion can be securely clamped adjacently to the separation location. The device also has an acting arrangement, which is adapted to apply a bending moment to the starting sheet metal about a bending axis extending along the separation location and/or to apply a tensile force directed away from the separation location to the second portion of the starting sheet metal. In addition, a tool is provided which for example can have a mechanical blade or another means, with which the forming of a crack can be initiated in the starting sheet metal at the separation location, for example by forming a notch in said sheet metal or by scratching into said sheet metal, and/or with which a shear stress can be produced at the separation location, which stress is directed at an incline or right angle to a plane in which the first portion of the starting sheet metal extends. The tool does not fully cut through the starting sheet metal at the separation location, but instead penetrates said sheet metal at most to a limited depth. Alternatively or additionally, an appropriate shear stress can also be created at the separation location in order to initiate the separation or breaking at the separation location. As a result of the shear stress or the notching at the separation location, as long as the acting arrangement applies the bending moment and/or the tensile force, the forming of a crack is initiated in the starting sheet metal at the separation location and the starting sheet metal is separated or fractured. A separation edge is formed at the first portion or at the second portion and runs along the grain boundary of the material of the starting sheet metal.

In a preferred embodiment the acting arrangement has a first acting unit and a second acting unit, which are movable relative to one another in a working direction. The tool is preferably movable in a working direction independently of the acting arrangement, but can also be connected to the first acting unit and therefore can move together with the first acting unit. The notching or application of the shear stress is preferably performed on the starting sheet metal in the working direction by the tool.

In one exemplary embodiment the first acting arrangement can have a first press part with a first press face and the second acting arrangement can have a second press part with a second press face. The press faces are each intended to rest on the second portion of the starting sheet metal when the bending moment and/or the tensile force are/is applied. The starting sheet metal is thus supported on opposite sides, specifically on one side of the separation location by the clamping means and on the other side of the separation location by the two acting units. An accidental plastic deformation of the first and the second portion during the separation process can thus be avoided.

It is also advantageous if the two press parts are mounted so as to be movable at an incline or right angle to the working direction. A tensile force can thus be applied to the second portion of the starting sheet metal in a very simple manner.

In one exemplary embodiment the press faces are oriented parallel to one another and at an incline to the working direction. As a result of the relative movement of the two press parts in the working direction, a tensile force can thus be applied additionally to the second portion (similarly to a wedge surface gear) without the need for a separate drive for this purpose.

The invention additionally relates to a sheet metal part that in particular can be used in a laminated core that conducts magnetic field lines. The sheet metal part is produced from a starting sheet metal by at least one separation process. The sheet metal part has at least one side edge, which runs along the grain boundaries along the material of the starting sheet metal. This side edge can be used particularly preferably in order to guide magnetic field lines into the sheet metal part and out from the sheet metal part. With constant magnetic field strength, it has been found that the side edge extending along the grain boundaries does not hinder the forming of the magnetic flux, and therefore a large magnetic flux density can be achieved.

Advantageous embodiments of the invention will become clear from the dependent claims, the description, and the drawing. Preferred embodiments will be explained in greater detail hereinafter with reference to the accompanying drawings, in which

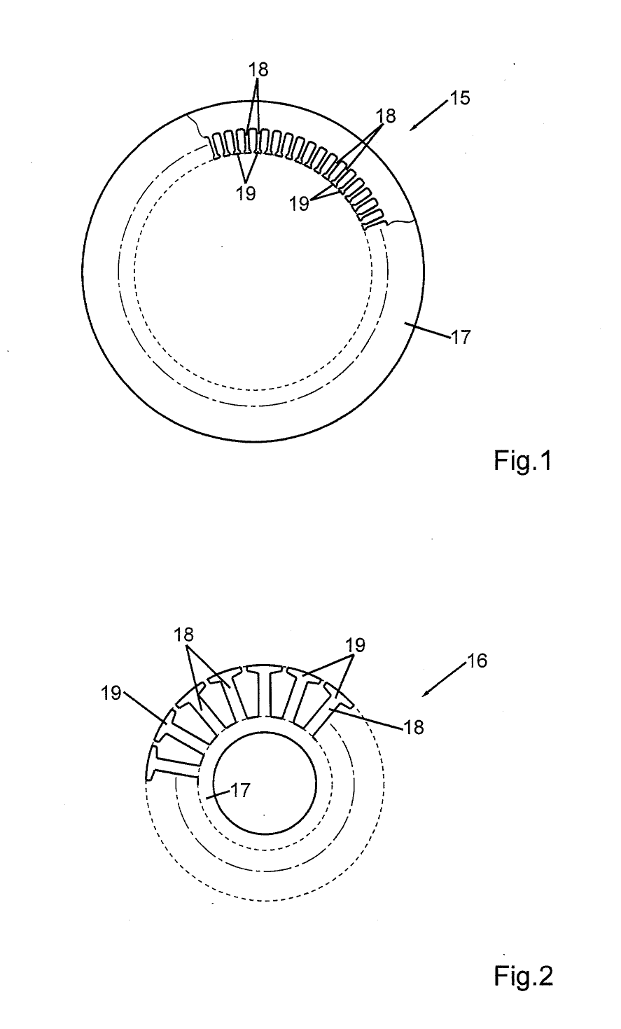

FIGS. 1 and 2 show, respectively, a schematic partial illustration of a rotor lamination and a stator lamination of an electric machine in a side view,

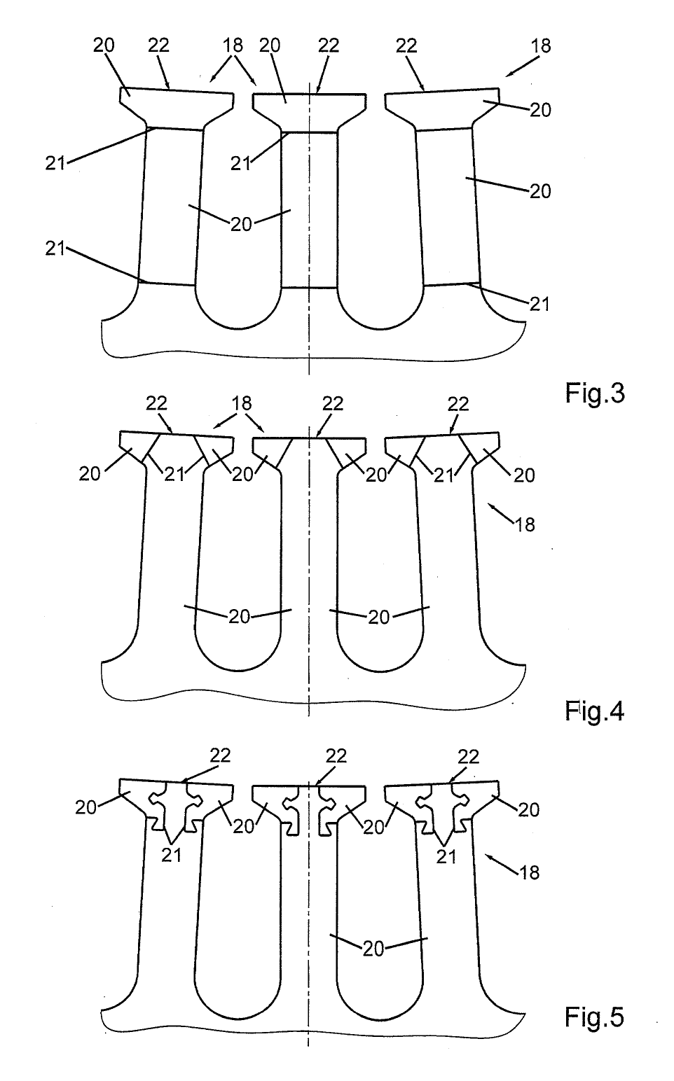

FIGS. 3 to 5 each show a schematic illustration of a plurality of teeth of the rotor lamination and the stator lamination according to FIGS. 1 and 2,

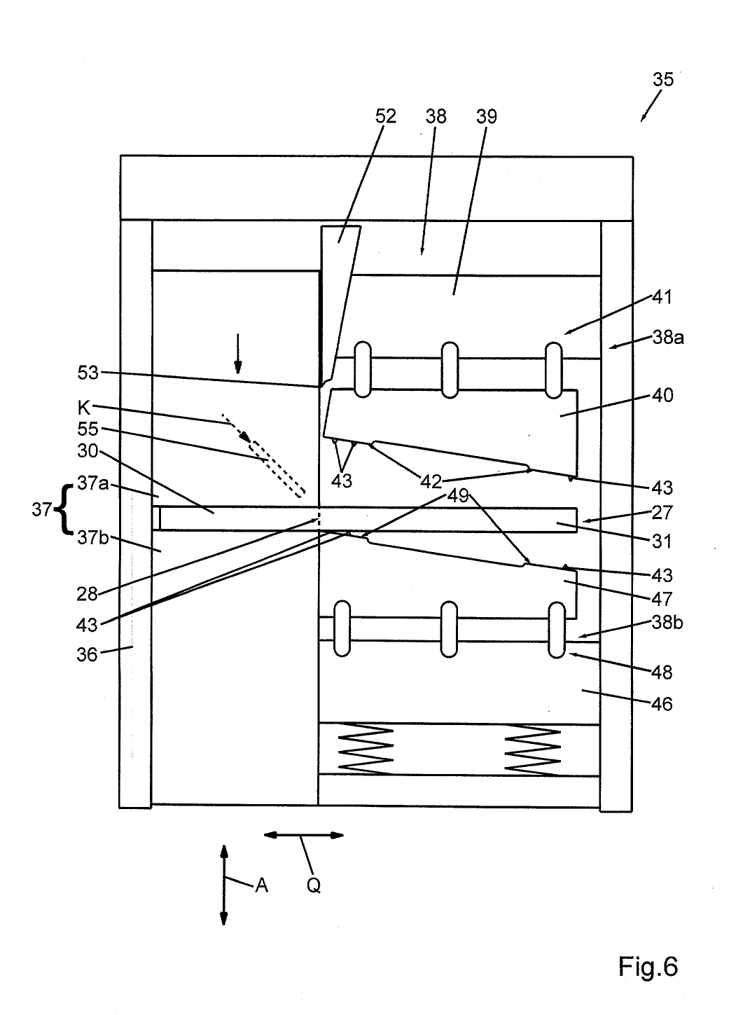

FIGS. 6 to 8 each show a block diagram of an exemplary embodiment of a device for separating a starting sheet metal at a separation location in different situations during the separation process, and

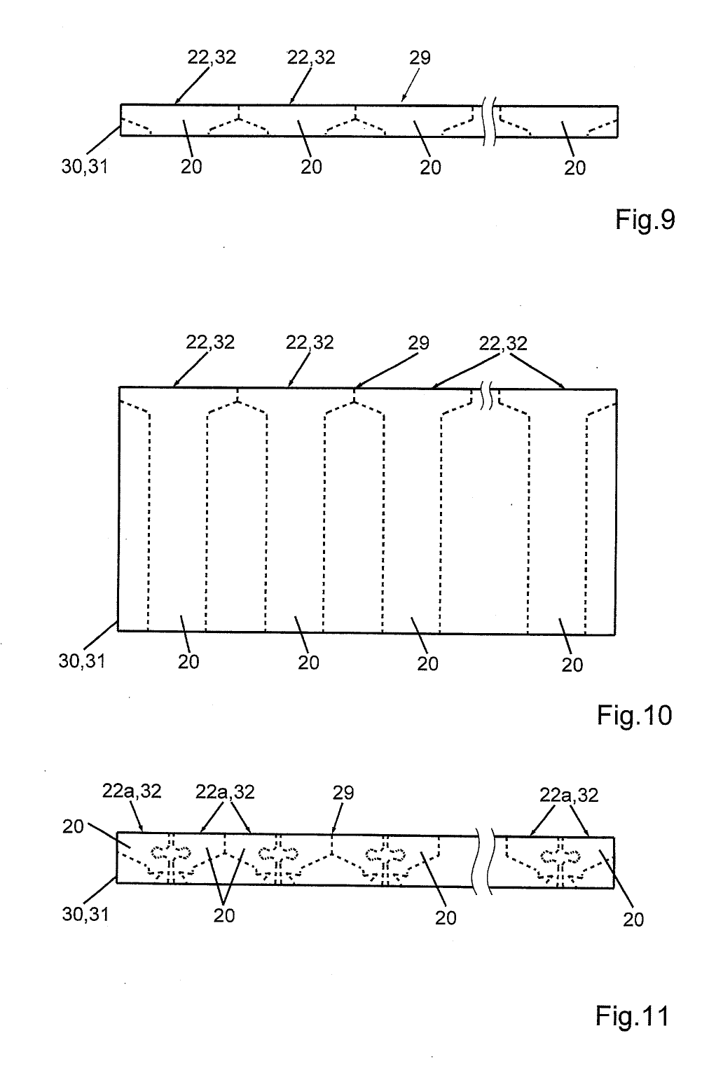

FIGS. 9 to 11 each show a schematic basic diagram of the production of a sheet metal part from a starting sheet metal separated at a separation location.

FIGS. 1 and 2 schematically illustrate, respectively, a stator lamination 15 and a rotor lamination 16. Such laminations are combined, respectively, in stators and rotors of electric machines to form laminated cores. They have a ring part 17, from which teeth 18 extend radially inwardly and outwardly respectively, said teeth having a tooth head 19 at their free end. Exemplary embodiments of teeth 18 for a stator lamination 15 or a rotor lamination 16 are illustrated in FIGS. 3 to 5. The teeth 18 can be connected to one another from a plurality of individual sheet metal parts 20 at the illustrated joint lines 21. A form-fitting and/or frictionally engaged connection can be produced at the joint lines 21. At the tooth head 19, each tooth 18 has a passing area 22, through which magnetic field lines exit from the tooth 18 and enter the tooth 18. The passing area 22 can be arranged on a single sheet metal part 20 or in portions on a number of interconnected sheet metal parts 20.

It goes without saying that, in a modification from FIGS. 3 to 5, each tooth 18 can be formed merely from a single sheet metal part 20 without seam and joint.

It should be noted at this juncture that the invention can relate not only to rotary electric machines, but also to linear drives. The stator lamination 15 and the rotor lamination 16 then are not formed annularly in a peripheral direction, but instead extend in a straight line. The shape of the teeth 18 can be provided here too in the manner as has been illustrated schematically in FIGS. 3 to 5.

The at least one sheet metal part 20 is produced by at least one separation process from a starting sheet metal 27. It is separated at a separation location 28, wherein at least one separation edge 29, and in accordance with the example two separation edges 29 (FIGS. 9 to 11), are created at the separation location and extend along a grain boundary of the material of the starting sheet metal 27. In accordance with the example the starting sheet metal 27 is separated at the separation location 28 into a first portion 30 and a second portion 31, wherein each of the two portions 30, 31 has a separation edge 29, which extends along the grain boundary of the material of the starting sheet metal 27. One or more sheet metal parts 20 can be separated off from these portions 30, 31 in subsequent separation processes, for example by punching, cutting, laser cutting, water jet cutting, etc., as is shown schematically in FIGS. 9 to 11. These sheet metal parts 20 have a side edge 32, which is formed in each case by a portion of the separation edge 29. Each side edge 32 can form a passing area 22 of a tooth 18 or an area portion 22a of a passing area 22 (see also FIGS. 3 to 5 by way of example).

An exemplary embodiment of a device 35 for separating the starting sheet metal 27 at the separation location 28 into the first portion 30 and the second portion 31 is illustrated in FIGS. 6 to 8. The device 35 has a machine frame 36. A clamping means 37 comprising a first clamping part 37a and a second clamping part 37b is arranged on the machine frame 36. The two clamping parts 37a, 37b are movable relative to one another in a working direction A. In accordance with the example the second clamping part 37b is fixed relative to the machine frame 36, whereas the first clamping part 37a is movable in the working direction A along the machine frame 36 and relative to the second clamping part 37b. The clamping means 37 is adapted to clamp the first portion 30 of the starting sheet metal 27 between the two clamping parts 37a, 37b.

Adjacently to the clamping means 37, the device 35 has an acting arrangement 38. The acting arrangement 38 is adapted to produce, at the separation location 28 of the starting sheet metal 27, a bending moment M about a bending axis B extending parallel or tangentially to the separation location 28. The acting arrangement 38 is also adapted to produce a tensile force Z parallel to the second portion 31 of the starting sheet metal 27, away from the separation location 28. In a modified embodiment, merely the bending moment M or merely the tensile force Z can also be produced, by way of an alternative.

The acting arrangement 38 has a first acting unit 38a and a second acting unit 38b, which are movable relative to one another in the working direction A. The first acting unit 38a has a ram 39, which is guided movably in the working direction A along the machine frame 36 and which can be moved in the working direction A by a drive (not illustrated). On the side facing towards the second acting unit 38b, a first press part 40 is arranged on the ram 39. The first press part 40 is supported on the ram 39 so that the force exerted by the ram 39 in the working direction A can be transferred to the first press part 40.

The first press part 40 is mounted on the ram 39 at an incline or right angle to the working direction A by means of a first bearing means 41 so as to be movable in a transverse direction Q. The press part optionally can also be mounted additionally on the machine frame 36. The first press part 40 has, on its side facing towards the second acting unit 38b, at least one first press face 42, by means of which it bears against the second portion 31 of the starting sheet metal so as to exert the bending moment M and/or the tensile force Z. In the case of the exemplary embodiment described here, protrusions 43, such as spikes, nubs or the like, are provided in the region of the at least one press face 42 so that a force can also be applied via the first press part 40 parallel to the plane in which the at least one press face 42 extends. This plane is arranged in the exemplary embodiment at an incline to the working direction A. If the first press part 40 is disposed in a starting position at a distance from the second portion 31 of the starting sheet metal 27, the part of the at least one press face 42 that is arranged at a greater distance from the separation location 28 in the transverse direction Q is disposed closer to the starting sheet metal 27, as considered in the working direction A (FIG. 6).

The second acting unit 38b has a support part 46, on which a second press part 47 can be mounted movably in the transverse direction Q by means of a second bearing means 48, similarly to the mounting of the first press part 40. The second press part 47 has at least one second press face 49, which bears against the starting sheet metal 27 in order to produce the bending moment M and/or the tensile force Z. The at least one second press face 49 extends in a plane that is oriented parallel to the plane in which the at least one press face 42 extends. Similarly to the first press face 42, protrusions 43 are also provided in the region of the at least one second press face 49 in accordance with the example.

In accordance with the example, the support part 46 is supported on the machine frame 36 or a base spring-elastically in the working direction A. In a modification hereto, it could also be arranged movably in the working direction A, similarly to the ram 39.

A drivable tool 52 that is mounted movably in the working direction A additionally belongs to the device 35 and in the exemplary embodiment is embodied as a mechanical cutting tool having a blade 53. The tool 52 serves to form a notch at the separation location 28, said notch having a shallow depth T that is smaller than the thickness of the starting sheet metal 27 at the separation location 28. The depth T is preferably smaller than the thickness D of the starting sheet metal 27 at least by a factor of 3 to 5. In the exemplary embodiment the tool 52 is movable in the working direction A so that it acts on the starting sheet metal 27 at a cutting angle of approximately 90° relative to the plane of extension of the first portion 30.

Instead of the notching, a tool 52 can also be provided which produces a shear stress at the separation location 28 by means of a force exerted onto the starting sheet metal 27 preferably in the working direction A.

In any case, the tool 52 is adapted to produce small microcracks at the separation location 28 in order to initiate the breaking of the starting sheet metal 27 at the separation location 28. The tool 52 does not perform a cutting or punching operation and does not fully sever the starting sheet metal 27 at the separation location 28. A material flow is thus at least largely avoided. The grain boundaries are maintained at the resultant separation edges 29 of the two portions 30, 31, which improves the course of magnetic field lines at the separation edges 29 if a sheet metal part produced from the starting sheet metal is located within a magnetic field.

In order to increase the brittleness, the starting sheet metal can be cooled optionally, at least at the separation location 28. The cooling can be performed before the starting sheet metal 27 is introduced into the device 35. It is also possible to provide a coolant feed 55 at the device 35 in order to feed a cooling fluid K to the separation location 28. By way of example, liquid nitrogen LN can be used as cooling fluid K.

The method for separating the starting sheet metal 27 at the separation location 28 along the grain boundary of the material of the starting sheet metal 27 is as follows:

Firstly, a starting sheet metal 27 is provided and is introduced into the device 35. The first portion 30 of the starting sheet metal 27 is then clamped between the two clamping parts 37a, 37b, adjacently to the separation location 28.

In order to produce a brittle fracture at the separation location 28 or in order to improve the breaking at the separation location 28 along the grain boundary, at least the separation location 28 or the entire starting sheet metal 27 can be cooled by a cooling fluid K before or after the clamping of the starting sheet metal 27.

The second portion 31 of the starting sheet metal 27 is acted on by the acting arrangement 38 so that the second portion 31 of the starting sheet metal 27 is held between these press faces 42, 49. On account of the press faces 42, 49 extending from the first portion 30 at an incline to the working direction, a bending moment M about a bending axis B is produced at the separation location 28, at a right angle to the working direction A and the transverse direction Q. In addition, a tensile force Z is produced parallel to the direction of the course of the second portion 31. The direction of the tensile force Z runs parallel to the planes in which the press faces 42, 29 extend.

In order to produce the bending moment M and the tensile force Z, the ram 39 is moved towards the starting sheet metal 27 or the second acting unit 38b. In so doing, the second portion 31 of the starting sheet metal 27 firstly comes into contact with the first press part 40 and is then bent about the bending axis B until the second portion 31 is held between the two press faces or the two press parts 40, 47. As a result of the bearing means 41, 48, the two press parts 40, 47 can move away from the separation location 28 in the transverse direction Q. This results in the tensile force Z. The second portion 31 can be held for this purpose in a frictionally engaged and/or form-fitting manner between the two press faces 42, 49.

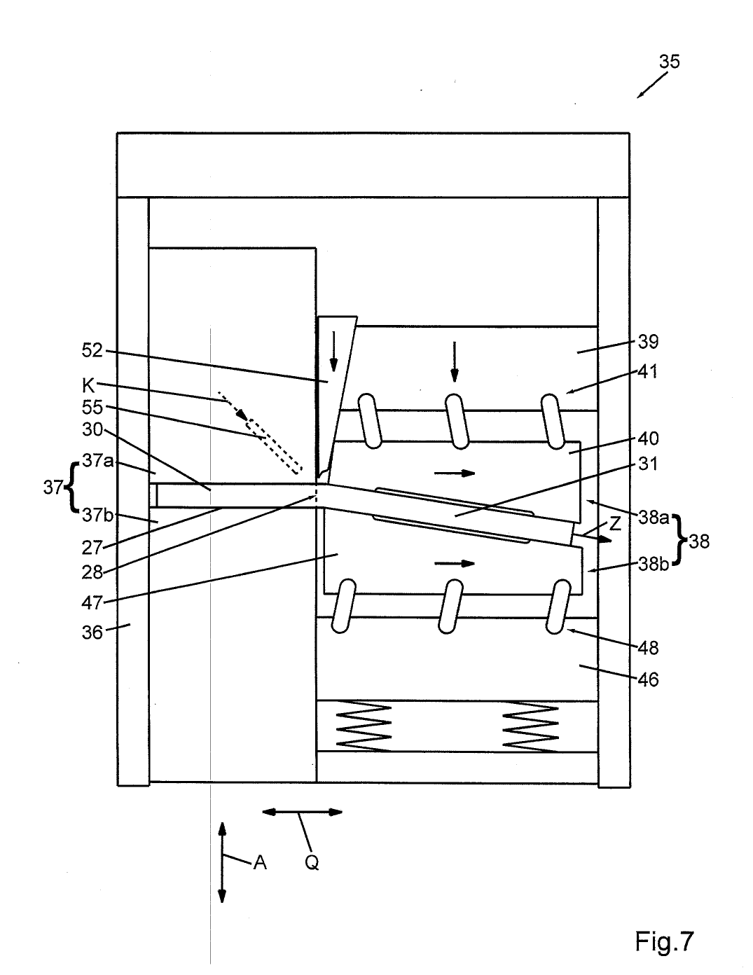

In accordance with the example the tensile stress Z is caused by the tool 52. The tool 52 has a wedge face 52a, on which the first press part 40 is supported. By means of a movement of the tool 52 towards the second acting unit 38b, the second press part 40 is moved away from the separation location 28 in the transverse direction Q. On account of the frictionally engaged and/or form-fitting coupling of the second press part 41 to the second portion 31, the second press part 41 is also moved away from the separation location 28 in the transverse direction Q. This situation is illustrated schematically in FIG. 7.

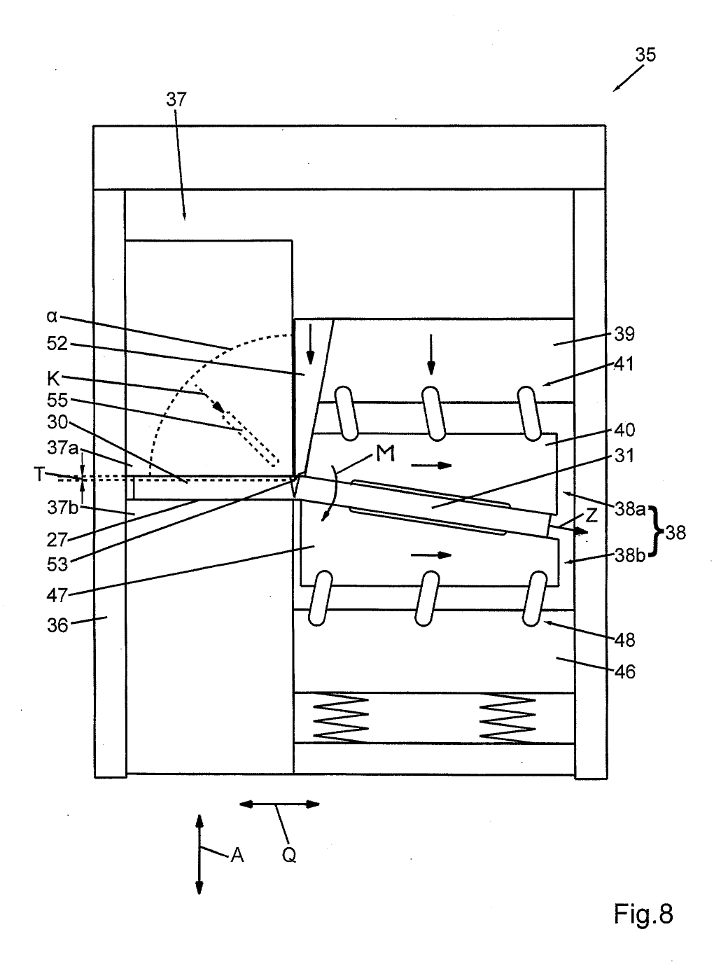

The tool 52, and in accordance with the example the blade 53, then forms a notch of shallow depth T in the surface region of the starting sheet metal 27 at the separation location 28 (FIG. 8). In so doing, the forming of a crack is initiated at the separation location 28, with the crack continuing from the notched surface, which is subject to a tensile stress, through the thickness of the starting sheet metal 27 at the separation location 28. The starting sheet metal 27 is separated between the first portion 30 and the second portion 31 by an initiated breaking operation, wherein a separation edge 29 is created at both portions 30, 31, said separation edges running along the grain boundaries of the material of the starting sheet metal 27.

It is advantageous when the clamping means 37 to a certain extent releases the pressure on the first portion 31 of the sheet metal at least in the region of the separation location 28 after the notching procedure. The sheet metal can thus be moved back from the blade 53, reducing the wear of the blade 53 or of the tool 52.

As a result of this separation method, a flow of the material of the starting sheet metal 27 at the separation location 28 is avoided or reduced to a minimum. The following is true for the method according to the invention:

σᵥ\sqrt{(σ_{B}+σ_{Z})²+3_{τ}_{²}}

with

σ_{V}: comparison stress

σ_{B}: bending stress

σ_{Z}: tensile stress

τ: shear stress

The tensile stress σ_{Z} is provided here by the tensile force Z, and the bending stress σ_{B} is provided by the bending moment M. The shear stress τ is caused by the tool 52.

The separation location 28 in accordance with the example has a straight course, at least in part, but can also have an at least partially curved course.

As shown in FIGS. 9 to 11 and already explained, a sheet metal part 20 can then be separated off from the two portions 30, 31 of the starting sheet metal 27 by an arbitrary separation method, said sheet metal part having a side edge 32 formed at least by a portion of the separation edge 29.

The invention relates to a sheet metal part 20 that is produced from a starting sheet metal 27 and has at least one side edge 32, which extends along the grain boundaries of the material of the starting sheet metal 27. A method and a device for separating or breaking the starting sheet metal 27 at a separation location 28, with said separation/breaking being initiated by forming a notch in the starting sheet metal or by scratching or cutting into the starting sheet metal, are also proposed. The starting sheet metal is clamped via a first portion 30 adjacently to the separation location 28. On the side of the separation location 28 opposite the first portion 30, there is disposed a second portion 31 of the starting sheet metal 27, which second portion is acted on in order to produce a bending moment M about a bending axis B at the separation location 28 and/or in order to produce a tensile force Z directed away from the separation location 28. By forming a notch of limited depth and/or by producing a shear stress at the separation location 28, the forming of a crack is preferably initiated at the separation location 28, and separates the second portion 31 from the first portion 30 along the grain boundary of the material of the starting sheet metal 27.

### LIST OF REFERENCE SIGNS

15 stator lamination
16 rotor lamination
17 ring part
18 tooth
19 tooth head
20 sheet metal part
21 joint line
22 passing area
22a area portion of the passing area
27 starting sheet metal
28 separation location
29 separation edge
30 first portion
31 second portion
32 side edge
35 device
36 machine frame
37 clamping means
37a first clamping part
37b second camping part
38 acting arrangement
38a first acting unit
38b second acting unit
39 ram
40 first press part
41 first bearing means
42 first press face
43 protrusion
46 support part
47 second press part
48 second bearing means
52 tool
53 blade
55 coolant feed
α cutting angle
σ_{B} bending stress
σ_{V} comparison stress
σ_{Z} tensile stress
τ shear stress
A working direction
B bending axis
K cooling fluid
M bending moment
T depth
Z tensile force

1. A method for separating a starting sheet metal (27) at a separation location (28), the method comprising:
clamping the starting sheet metal (27) in a first portion (30) adjacently to the separation location (28),
one or both of applying a bending moment (M) to the starting sheet metal (27) about a bending axis (B) extending along the separation location (28) and applying a tensile force (Z) directed away from the separation location (28) to a second portion (31) of the starting sheet metal (27) arranged on a side of the separation location (28) opposite the first portion (30),
initiating formation of a crack at the separation location (28) whilst the bending moment (M) and/or the tensile force (Z) are/is acting on the starting sheet metal (27), wherein the separation of the starting sheet metal (27) is initiated such that a separation edge (29) of the first portion (30) and/or the second portion (31) is formed at the separation location (28) and runs along a grain boundary of the starting sheet metal (27).

2. The method according to claim 1, further comprising initiating the formation of a crack by one or more of forming a notch or an incision of limited depth (T) or by applying a shear stress.

3. The method according to claim 2, further comprising producing the notch and/or the shear stress using a blade (53) that acts mechanically on the starting sheet metal (27).

4. The method according to claim 1, further comprising the tensile force (Z) acting parallel to the second portion (31) of the starting sheet metal (27).

5. The method according to claim 1, further comprising cooling the starting sheet metal (27) at least at the separation location (28) before or during the separation.

6. The method according to claim 5, further comprising directing a cooling fluid (K) onto the starting sheet metal (27) to cool the separation location (28).

7. The method according to claim 1, further comprising causing the separation at the separation location (28) by creation of a brittle fracture.

8. The method according to claim 1, further comprising separating off at least one sheet metal part (20) from the first portion (30) and/or the second portion (31), wherein the at least one sheet metal part (20) has a side edge (32) formed at least by a portion of the separation edge (29).

9. The method according to claim 1, wherein the separation location (28) has a straight and/or curved course, at least in part.

10. A device for separating a starting sheet metal (27) at a separation location (28), the device comprising:
a clamp device (37) adapted to securely clamp a first portion (30) of a starting sheet metal (27) adjacently to the separation location (28),
an acting arrangement (38) adapted to one or both of apply a bending moment (M) to the starting sheet metal (27) about a bending axis (B) extending along the separation location (28) and apply a tensile force (Z) directed away from the separation location (28) to a second portion (31) of the starting sheet metal (27) arranged on a side of the separation location (28) opposite the first portion (30),
a tool (52), which is designed, by acting on the starting sheet metal (27), to form a crack at the separation location (28) whilst the bending moment (M) and/or the tensile force (Z) are/is acting on the starting sheet metal (27), thus initiating separation of the starting sheet metal (27), such that a separation edge (29) of the first portion (30) and/or the second portion (31) is formed at the separation location (28) and runs along a grain boundary of the starting sheet metal (27).

11. The device according to claim 10, wherein the acting arrangement (38) comprises a first acting unit (38a) and a second acting unit (38b), which are movable relative to one another in a working direction (A).

12. The device according to claim 11, wherein the first acting unit (38a) comprises a first press part (40) and the second acting unit (38b) comprises a second press part (47), which press against the second portion (31) of the starting sheet metal (27) from opposite sides to produce the bending moment (M) and/or the tensile force (Z).

13. The device according to claim 12, wherein the first press part (41) and the second press part (47) individually comprise a press face (42, 49), which is oriented at an incline to the working direction (A) and is configured to bear against the second portion (31) of the starting sheet metal (27) whilst the bending moment (M) and/or the tensile force (Z) are/is being applied.

14. The device according to claim 12, wherein the first press part and the second press part are mounted movably at an incline or right angle to the working direction (A).

15. A sheet metal part (20), for use in a laminated core that conducts magnetic field lines,
wherein the sheet metal part (20) is produced from a starting sheet metal (27) by at least one separation process, and
wherein the sheet metal part (20) comprises at least one side edge (32) which runs along grain boundaries of material of the starting sheet metal (27).

16. The sheet metal part according to claim 15, wherein the side edge (32) running along the grain boundaries of the material of the starting sheet metal (27) forms a passing area (22) for magnetic field lines.
